(19) United States
(12) Patent Application Publication
(10) Pub. No.: US 2016/0129802 A1
(43) Pub. Date: May 12, 2016

(54) ELECTRIC VEHICLE CAPABLE OF DISPLAYING RECHARGING POWER AND FEE

(71) Applicant: Hyundai Motor Company, Seoul (KR)

(72) Inventors: Dong Pil Yoon, Incheon (KR); Jae Hoon Cho, Suwon (KR); Dae Sik Kim, Seoul (KR); Ji Hoon Kang, Seoul (KR)

(21) Appl. No.: 14/935,389

(22) Filed: Nov. 7, 2015

(30) Foreign Application Priority Data
Nov. 12, 2014 (KR) 10-2014-0157379

(51) Int. Cl. B60L 11/18; G06Q 50/06; G06Q 30/02; G01S 19/42

(52) U.S. Cl. CPC B60L 11/1848; G01S 19/42; G06Q 50/06; G06Q 30/0283

(57) ABSTRACT

A method of calculating and displaying recharging power and fee for main battery recharging of an electric vehicle or a hybrid vehicle is provided. The method uses power consumption information of a registered location received from a grid server via a global positioning system (GPS) and a wireless communication device. Additionally, current recharging power is measured in response to a process recharging being started, a real-time base price of a current registered location is received via a wireless communication device from an external server. A current recharging fee is then calculated using the measured current recharging power and the received real-time base price of the current registered location and the calculated current recharging fee is output.

### CROSS-REFERENCE TO RELATED APPLICATION(S)

This application claims the benefit of Korean Patent Application No. 10-2014-0157379, filed on Nov. 12, 2014, which is hereby incorporated by reference as if fully set forth herein.

### BACKGROUND

1. Field of the Invention

The present invention relates to information regarding main battery recharging of an electric vehicle and a hybrid vehicle and, more particularly, to a method of calculating and displaying recharging power and fee for main battery recharging of an electric vehicle or a hybrid vehicle using power consumption information of a registered location received from a grid server via a global positioning system (GPS) and a wireless communication device.

2. Discussion of the Related Art

A method of recharging a main battery of an electric vehicle or a hybrid vehicle is generally divided into a recharging method using a public recharging facility and a recharging method using residential power. In a conventional technology, when the public recharging facility is used, a user may detect recharging power and an associated fee directly through a charger or using a general method of accessing payment information of a credit card via a text message/Internet access, etc. However, when the residential power is used for recharging, recharging fee/power may not be detected in real time, and a ratio of vehicle recharging fee/power to a whole monthly fee/power for electricity usage may not be detected. Further, the determination of driving efficiency (e.g., a unit fee for a driving distance) may be difficult to determine

### SUMMARY

The present invention provides an electric vehicle capable of calculating a fee and/or power used for recharging a vehicle containing a high-capacity rechargeable battery from a whole usage fee and/or power of a registered location, and providing the calculated fee and/or power to a user, and a method of controlling the same. Technical problems to be solved by the present invention are not limited to the above-mentioned technical problems, and other technical problems not mentioned herein may be clearly understood by those skilled in the art from description below.

To achieve these objects and other advantages and in accordance with the purpose of the invention, as embodied and broadly described herein, a method of managing a recharging fee of an electric vehicle may include measuring current recharging power in response to starting a recharging process, receiving a real-time base price of a current registered location via a wireless communication device from an external server, calculating a current recharging fee using the measured current recharging power and the received real-time base price of the current registered location, and outputting the calculated current recharging fee.

In another aspect of the present invention, an electric vehicle capable of managing a recharging fee may include a wireless communication device configured to receive information from an external server, a recharging power/power consumption calculation unit configured to measure current recharging power in response to the start of a recharging process, and calculate a current recharging fee using the measured current recharging power and a real-time base price of a current registered location when the real-time base price of the current registered location is received via the wireless communication device, and an output unit configured to output the calculated current recharging fee.

In another aspect of the present invention, a recharging fee management system may include a telematics management system (TMS) server configured to receive at least one of power consumption information for each registered location, use classification and fee range level information, and base price information for each range level and time interval from a grid server, and calculate a real-time base price of a current registered location, and an electric vehicle configured to receive the real-time base price of the current registered location from the TMS server in response to recharging being started, measure current recharging power, calculate a current recharging fee using the measured current recharging power and the received real-time base price of the current registered location, and output the calculated current recharging fee.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a block diagram illustrating an exemplary system configuration for providing recharging fee information to an electric vehicle according to an exemplary embodiment of the present invention;

FIG. 2 is a block diagram illustrating an exemplary component of a vehicle controller illustrated in FIG. 1 according to an exemplary embodiment of the present invention;

FIG. 3 is a flowchart illustrating an exemplary method of outputting a recharging fee from the vehicle controller according to an exemplary embodiment of the present invention;

FIG. 4 is a block diagram illustrating an exemplary operational process of a telematics management system (TMS) server for providing fee calculation source information according to an exemplary embodiment of the present invention;

FIGS. 5A-5B are diagrams illustrating an exemplary form in which power rate information calculated in the vehicle is displayed together with driving information according to an exemplary embodiment of the present invention; and

FIGS. 6A-6C are diagrams illustrating an exemplary form in which power rate information calculated in the vehicle is displayed for each period according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings. Wherever possible, the same reference numbers will be used throughout the drawings to refer to the same or like parts. The suffixes “module” and “unit” of elements herein are used for convenience of description and thus can be used interchangeably and do not have any distinguishable meanings or functions. When a detailed description of known technology related to description of exemplary embodiments disclosed in this specification is determined to obscure the essence of the embodiments disclosed in this specification, the detailed description will be omitted. In addition, accompanying drawings merely aid in understanding of the embodiments disclosed in this specification, and a technical spirit disclosed in this specification is not limited to the accompanying drawings. It should be understood that the present invention includes all modifications, equivalents or substitutes within the spirit and scope of the present invention.

To calculate and display recharging power of an electric vehicle and a fee thereof for each registered location, the present invention proposes that, in response to a telematics management system (TMS) center wirelessly transmitting base price information according to real-time power consumption of the registered location where the vehicle is being recharged, a recharging fee may be calculated and output based on the base price information received from the vehicle and a measured current recharging power. In particular, the TMS center may be configured to acquire information regarding real-time and monthly power consumption, use classification, fee range levels, and base price information based on the level and time for each registered location using a grid server from a power company that supplies power to each registered location. The information may be managed through an account for a vehicle driver.

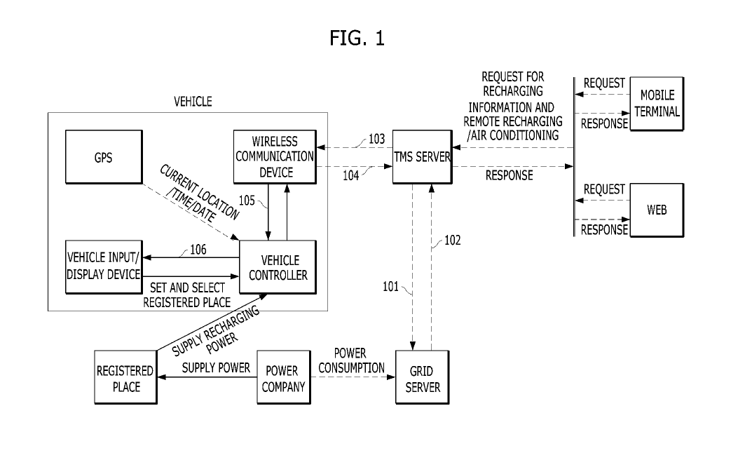

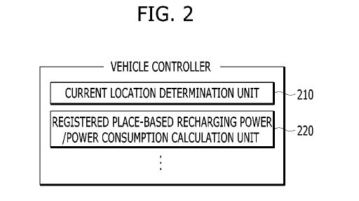

Hereinafter, a description will be given of a system for implementing the present invention with reference to FIGS. 1 and 2. FIG. 1 is a block diagram illustrating an example of a system configuration for providing recharging fee information to an electric vehicle according to an exemplary embodiment of the present invention, and FIG. 2 is a block diagram illustrating an example of a component of a vehicle controller illustrated in FIG. 1.

Referring to FIG. 1, the system according to the present exemplary embodiment may include a vehicle, a TMS server, a grid server, a power company, and a registered location. In addition, as necessary, the TMS server may be configured to provide recharging fee-related information and/or a remote control command through a telematics function, etc. to a mobile terminal (e.g., a smartphone) or a web server on a request-response basis.

Particularly, the vehicle may include a global positioning system (GPS), an input/display device, a vehicle controller, and a wireless communication device. As illustrated in FIG. 2, the vehicle controller may include at least a current location determination unit 210 and a registered place-based recharging power/power consumption calculation unit 220. The vehicle controller may include more components such as an air conditioning controller, an airbag controller, a braking controller, etc. In addition, the current location determination unit 210 and the registered place-based recharging power/power consumption calculation unit 220 may be implemented as separate devices as in FIG. 2, and one device may be configured to perform functions of the two components.

Hereinafter, a more detailed description will be given of functions of the respective components. First, the power company provides power to the registered location, and the vehicle may be recharged at the registered location. In addition, the power company provides information regarding power used in the registered location to the grid server.

The grid server may be configured to receive various requests 101 from the TMS server, and transmit responses 102 thereto to the TMS server. The requests 101 from the TMS server may include a request for authentication of an account including registered location information of the driver, a request for real-time/monthly power consumption for each registered location, a request for use classification and fee range levels, etc. The responses 102 of the grid server may include an account verification response, information regarding the real-time/monthly power consumption, information regarding the use classification and fee range levels, base price information for each range level and time interval, etc.

The TMS server may be configured to provide a telematics-related request and fee calculation source information 103 to the wireless communication device of the vehicle, and receive recharging power measured by the vehicle and power consumption fee information 104 from the wireless communication device. The telematics-related request and fee calculation source information 103 may include power consumption information for each registered location, information regarding use classification and fee range levels, base price information for each range level and time interval, information regarding a request for remote recharging/air conditioning, a request for account authentication, etc.

Meanwhile, the wireless communication device of the vehicle may be configured to attempt account authentication for the TMS server during recharging at a preregistered location, and deliver current time/date information together with the telematics-related request and fee calculation source information 103 to the registered place-based recharging power/power consumption calculation unit 220 when authentication is confirmed.

The current location determination unit 210 may be configured to determine a location at which the vehicle is currently being recharged. Specifically, the current location determination unit 210 may be configured to determine the current location by comparing current location information using the GPS (e.g., Cur_Pos_GPS) with current location information of the wireless communication device (e.g., Cur_Pos_3G) to verify whether both locations are within a certain range (e.g., whether Cur_Pos_GPS is present within a Cur_Pos_3G-radius), and determine validity with respect to a registered location (e.g., whether it is present within a certain radius). Validity may be further determined based on a charger type, a recharging voltage, a recharging level, power use, etc. at the time of recharging.

The current location determination unit 210 may be configured to store a last driving location when starting is turned off (e.g., a key off state) in a region out of the range of the GPS (e.g., beyond the GPS range), and utilize latest GPS location information (e.g., Latest_Pos_GPS) when the GPS is not received for a particular period of time or more at the time of recharging. In addition to the GPS, the current location determination unit 210 may be configured to determine current location based on location information received from wireless communication system like Long Term Evolution (LTE), Wide Band Code Division Multiple Access (WCDMA), Wi-Fi Network.

Further, the current location determination unit 210 may be configured to determine current location based on user input by selection of predefined menu. A user may set the registered location using the input/display device, and automatically or manually select current location determination. The present device may have a display function implemented in a cluster or an audio, video, navigation (AVN) system of the vehicle, and an input function implemented through the AVN system or a key button, a touchpad/touchscreen, a jog dial, etc.

When recharging is started, the registered location-based recharging power/power consumption calculation unit 220 may be configured to calculate recharging power using a recharging voltage and current, and calculate a recharging fee using real-time base price information based on fee range levels of the registered location. Recharging power and power consumption information may be delivered (106) to the wireless communication device by calculated power consumption and a daily/monthly/yearly fee (e.g., any type of fee arrangement). In particular, when the fee range levels and the base price are changed from whole power information of the registered location, the change may be reflected. When whole power reaches a particular power of each range level, a warning of the fee range change and remaining power may be delivered to the user via the wireless communication device.

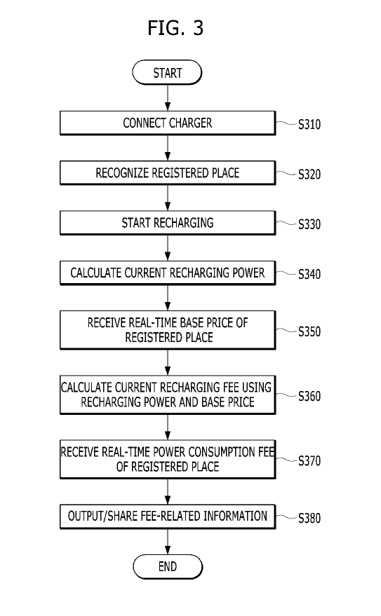

Hereinafter, a description will be given of a process in which the above-described operation is performed in the vehicle with reference to FIG. 3. The method as described herein below may be executed by the vehicle controller. FIG. 3 illustrates an example of a method of outputting a recharging fee from the vehicle controller according to an exemplary embodiment of the present invention. Referring to FIG. 3, in response to the charger being connected in S310, the registered location may be recognized in S320. The registered location may be recognized automatically using GPS/wireless communication location comparison, validity determination, etc. as described above by the current location determination unit 210, or manually through operation of the input/display device by the user (e.g., by receiving a user input).

When recharging is started in S330, the registered location-based recharging power/power consumption calculation unit 220 may be configured to calculate current recharging power in S340, receive the real-time base price information of the registered location received from the TMS server via the wireless communication device in S350, and calculate a current recharging fee by combining the calculated recharging power and the received real-time base price information in S360. In particular, the registered location-based recharging power/power consumption calculation unit 220 may be configured to store accumulated recharging power and an accumulated charging fee for each period (e.g., for each day, month, year, or other time period).

When the calculation of the recharging fee is completed, the registered place-based recharging power/power consumption calculation unit 220 may be configured to directly provide the user with real-time power consumption fee information regarding the registered location received from the TMS server via the wireless communication device in S370 and fee-related information (e.g., the accumulated recharging power/fee for each period, current recharging power/fee, etc.) calculated and stored by the registered location-based recharging power/power consumption calculation unit 220 using the input/display device in S380. Alternatively, the registered location-based recharging power/power consumption calculation unit 220 may be configured to share or transmit the information with/to the TMS server via the wireless communication device in S380. When the fee-related information is output, it may be possible to output information such as a fee range level change warning alarm or fee range level change remaining power received from the TMS server via the wireless communication device.

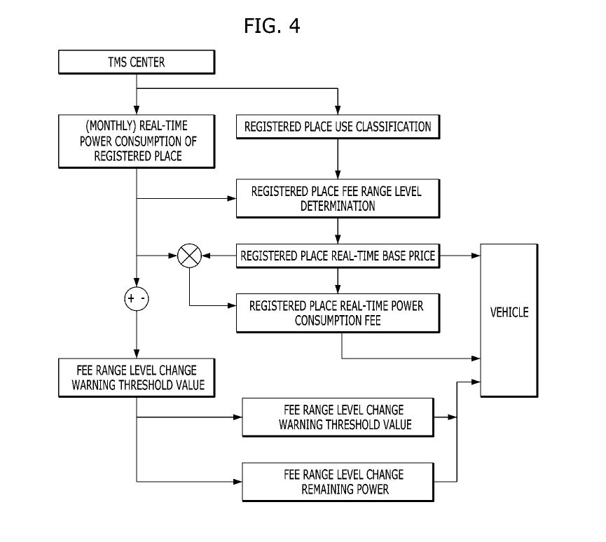

Subsequently, a description will be given of an operation of the TMS server (e.g., a center) with reference to FIG. 4. FIG. 4 illustrates an example of an operational process of the TMS server for providing fee calculation source information according to an exemplary embodiment of the present invention.

Referring to FIG. 4, the TMS center may be configured to determine a fee range level of the registered location using information regarding monthly/real-time power consumption of the registered location and use classification of the registered place (e.g., for family use, industrial/commercial use, etc.) based on the information 102 received in response to the request 101 to the grid server, and acquire real-time base price information regarding the registered location based on the determination.

In addition, the TMS center may be configured to calculate a real-time power consumption fee of the registered place using the real-time base price information regarding the registered location and the real-time power consumption of the registered location. Further, the TMS center maybe configured to generate fee range level change warning alarm information and fee range level change remaining power information based on a threshold value of fee range level change warning. As described above, information calculated or generated by the TMS center may be wirelessly transmitted to the vehicle.

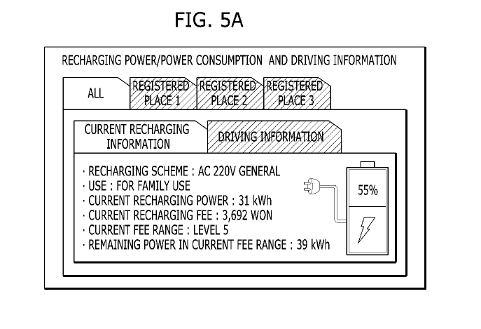

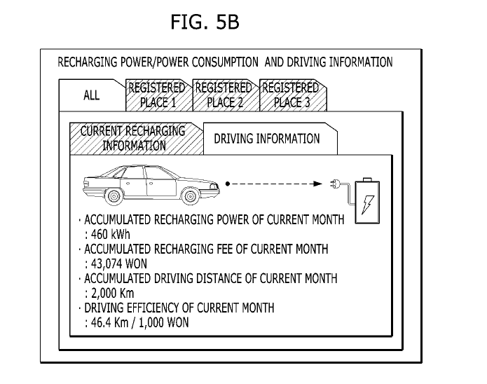

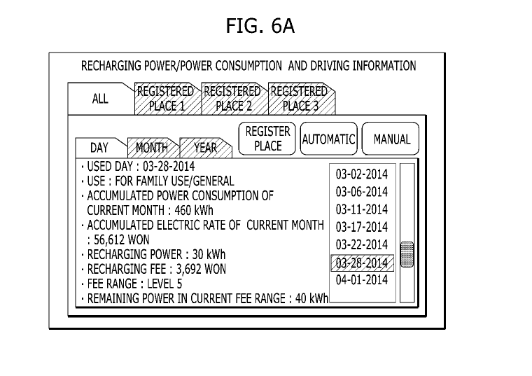

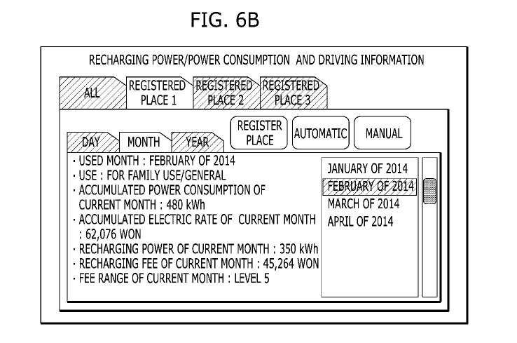

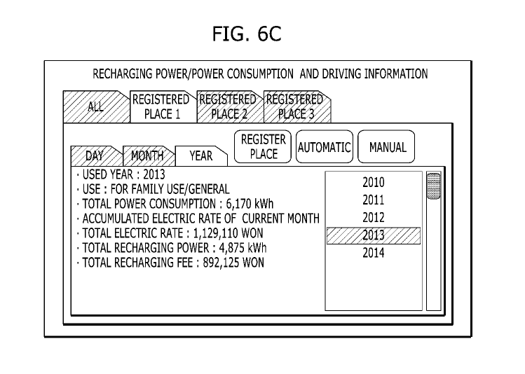

Through the above-described process, the vehicle may be configured to calculate and store a power consumption fee using recharging power and base price information in real time and for each time period. Hereinafter, a description will be given of forms in which stored power/fee-related information may be displayed with reference to FIGS. 5A-5B and 6A-6C. In particular, in FIGS. 5A-5B and 6A-6C, it may be assumed that the power/fee-related information is displayed via a display of a touchscreen-type AVN system. FIGS. 5A and 5B illustrate a form in which power rate information calculated in the vehicle may be displayed together with driving information according to an exemplary embodiment of the present invention.

Referring to FIG. 5A, recharging power/power consumption and driving information may be provided for each registered location or all registered locations, and information regarding current recharging power, a current recharging fee, a current fee range, remaining power in the current fee range, etc. may be displayed as current recharging information. In addition, referring to FIG. 5B, monthly accumulated recharging power/fee information together with driving distance and efficiency information may be displayed as driving information.

FIGS. 6A-6C illustrate a form in which power rate information calculated in the vehicle may be displayed for each period according to an exemplary embodiment of the present invention. FIG. 6A illustrates a form of providing daily recharging power/fee information for a particular registered location, FIG. 6B illustrates a form of providing monthly recharging power/fee information for the registered location, and FIG. 6C illustrates a form of providing yearly recharging power/fee information for the registered location.

Through the above-described exemplary embodiments, it may be possible to enhance user convenience by providing power information used to recharge an electric vehicle or a hybrid vehicle more accurately separated from whole power consumption (e.g., monthly power consumption/fee) of the registered location. In addition, it may be possible to detect an actual recharging fee by reflecting a fee range level of the registered location in real time. When a particular power consumption is reached while the vehicle is being recharged, a fee range level change (e.g., a fee increase) and remaining power may be remotely reported to the user in advance to prevent unnecessary recharging, thereby more efficiently managing power consumption.

In addition, user convenience may be enhanced by providing period-based or monthly/yearly electric driving information (e.g., accumulated driving distance, driving efficiency=driving distance/unit fee) using a display device within the vehicle or mobile device or service and web service. In addition, it may be possible to detect and manage daily/monthly/yearly recharging power/power consumption information for a plurality of registered locations or for each registered location. Further, when a remote service is provided via the mobile and web service, the user may remotely monitor recharging power/power consumption information in real time, and adjust recharging or air conditioning in connection with a remote recharging/air conditioning control function.

Although the above exemplary embodiments have been described based on the electric vehicle, it is clearly understood by those skilled in the art that the invention may be applied to any vehicle such as a plug-in hybrid vehicle having a power system recharged with power of the registered location.

According to at least one exemplary embodiment of the present invention, it may be possible to obtain the following effects.

It may be possible to visually provide the user with recharging fee/power of a vehicle containing a high-capacity rechargeable battery from a whole usage fee/power of a registered location by comprehensively considering information regarding a current location, a time and date, power consumption of the registered place, etc.

In addition, it may be possible to detect an actual recharging fee by reflecting a fee range level of the registered location in real time. When a particular power consumption is reached while the vehicle is being recharged, fee range level change and remaining power may be remotely reported to the user in advance to prevent unnecessary recharging, thereby more efficiently managing power consumption.

Further, user convenience may be enhanced by providing period-based or monthly/yearly electric driving information (e.g., accumulated driving distance, driving efficiency=driving distance/unit fee) using a display device of the vehicle and web service.

Additionally, it may be possible to detect and monitor daily/monthly/yearly recharging power/power consumption information for a plurality of registered locations or for each registered location.

When a remote service is provided via a mobile and web service, the user may remotely monitor recharging power/power consumption information in real time, and adjust recharging or air conditioning in connection with a remote recharging/air conditioning control function.

Effects that may be obtained from the present invention are not limited to the above-mentioned effects, and other effects not mentioned herein may be clearly understood by those skilled in the art from description below.

Therefore, the above detailed description should be construed in all aspects as illustrative and not restrictive. The scope of the invention should be determined by the appended claims and their legal equivalents, and all changes coming within the equivalency range of the appended claims are to be embraced therein.

What is claimed is:

1. A method of managing a recharging fee of an electric vehicle, comprising:
measuring, by a controller, current recharging power in response to a recharging process starting;
receiving, by the controller, a real-time base price of a current registered location via a wireless communication device from an external server;
calculating, by the controller, a current recharging fee using the measured current recharging power and the received real-time base price of the current registered location; and
outputting, by the controller, the calculated current recharging fee.

2. The method according to claim 1, further comprising:
recognizing, by the controller, the current registered location among at least one preset registered location when a charger of the current registered location is connected.

3. The method according to claim 2, wherein the recognizing includes:
acquiring, by the controller, first location information recognized using a global positioning system (GPS) and second location information recognized using the wireless communication device;
determining, by the controller, whether the first location information and the second location information are within a predetermined range; and
recognizing, by the controller, one of the at least one preset registered location as the current registered location when the predetermined range is satisfied and the first location information is within a predetermined radius of the one of the at least one preset registered location as a result of the determination.

4. The method according to claim 2, further comprising:
manually receiving, by the controller, the current registered place from a driver via an input device when the recognizing of the current registered location fails.

5. The method according to claim 1, further comprising:
receiving, by the controller, a real-time power consumption fee of the current registered location from the external server; and
outputting, by the controller, the real-time power consumption fee together with the calculated current recharging fee.

6. The method according to claim 1, wherein the receiving of the real-time power consumption fee includes:
receiving, by the controller, at least one of power consumption information for each registered location, use classification and fee range level information, and base price information for each range level and time interval.

7. The method according to claim 6, wherein the external server includes a telematics management system (TMS) server.

8. The method according to claim 7, wherein the TMS server is configured to receive the at least one of power consumption information for each registered location, use classification and fee range level information, and base price information for each range level and time interval from a grid server, and calculate the real-time base price of the current registered location.

9. The method according to claim 1, wherein the calculation includes:
storing, by the controller, an accumulated recharging fee for each particular period.

10. The method according to claim 1, wherein the measuring of the current recharging power includes:
storing, by the controller, an accumulated recharging fee for each particular period.

11. An electric vehicle capable of managing a recharging fee, comprising:
a wireless communication device configured to receive information from an external server;
a controller configured to measure current recharging power in response to a recharging process being started, and calculate a current recharging fee using the measured current recharging power and a real-time base price of a current registered location when the real-time base price of the current registered location is received from the wireless communication device; and
an output unit configured to output the calculated current recharging fee.

12. The electric vehicle according to claim 11, wherein the controller is further configured to:
recognize the current registered location among at least one preset registered location when a charger of the current registered location is connected.

13. The electric vehicle according to claim 12, wherein the controller is configured to:
acquire first location information recognized using a global positioning system (GPS) and second location information recognized using the wireless communication device;
determine whether the first location information and the second location information are within a predetermined range; and
recognize one of the at least one preset registered location as the current registered location when the certain range is satisfied and the first location information is within a particular radius of the one of the at least one preset registered location as a result of the determination.

14. The electric vehicle according to claim 12, wherein the controller is configured to manually receive the current registered location from a driver via an input device when the current registered location fails to be recognized.

15. The electric vehicle according to claim 11, wherein the output unit is configured to output a real-time power consumption fee of the current registered location together with the calculated current recharging fee when the real-time power consumption fee is received from the external server via the wireless communication device.

16. The electric vehicle according to claim 11, wherein the real-time base price is received together with at least one of power consumption information for each registered location, use classification and fee range level information, and base price information for each range level and time interval.

17. The electric vehicle according to claim 16, wherein the external server includes a TMS server and the TMS server is configured to receive the at least one of power consumption information for each registered location, use classification and fee range level information, and base price information for each range level and time interval from a grid server, and calculate the real-time base price of the current registered location.

18. The electric vehicle according to claim 11, wherein the controller is configured to store an accumulated recharging fee for each particular period.

19. The electric vehicle according to claim 11, wherein the controller is configured to store an accumulated recharging fee for each particular period.

20. A recharging fee management system, comprising:
a TMS server configured to receive at least one of power consumption information for each registered location, use classification and fee range level information, and base price information for each range level and time interval from a grid server, and calculate a real-time base price of a current registered location; and
an electric vehicle configured to receive the real-time base price of the current registered location from the TMS server in response to a process recharging being started, measure current recharging power, calculate a current recharging fee using the measured current recharging power and the received real-time base price of the current registered location, and output the calculated current recharging fee.
